(19) United States
(12) Patent Application Publication
(10) Pub. No.: US 2008/0148095 A1
(43) Pub. Date: Jun. 19, 2008

(54) AUTOMATED MEMORY RECOVERY IN A ZERO COPY MESSAGING SYSTEM

(75) Inventors: Orlando J. Perdomo, Miami Beach, FL (US); Antonio E. Cuadra, Tamarac, FL (US); Charbel Khawand, Miami, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/611,045

(22) Filed: Dec. 14, 2006

(51) Int. Cl. G06F 11/14

(52) U.S. Cl. 714/6; 714/E11.113

(57) ABSTRACT

The disclosed invention includes a method for automatically recovering memory in a zero copy messaging system. In the method, ownership can be established between process executing in different processing units and allocated portions of a shared memory pool. The shared memory pool can be remotely located from the processing units. Ownership or control data of the allocated memory portions can be changed when control of the memory is transferred from one of the processes to another. Allocated portions of memory can be automatically recovered when processes owning the allocated portions are unexpectedly aborted before the allocated portions are able to be explicitly deallocated.

### BACKGROUND

1. Field of the Invention

The present invention relates to zero copy messaging and, more particularly, to automated memory recovery in a zero copy messaging system.

2. Description of the Related Art

Computing systems can share execution of two or more concurrent processes, which result in a sharing of a total computational load. This sharing can occur between different cores of a dual core processor, between different processors of a computing device having multiple processors on a single motherboard within an array of two or more linked parallel computing devices over dedicated channels connecting the devices, between two or more computing devices connected via a network, and the like.

Traditionally, a first process will execute within a first processing unit, which stores results and intermediate values in a first memory local to that unit. When processing is forwarded to a second processing unit, a portion of the first memory is copied to a second memory that is local to the second processing unit. The first memory is then deallocated. The second processing unit executes a second process based upon copied information and writes intermediate values and results in a second memory local to that unit. This same process of copying of local memory, forwarding the copied memory to a different memory local to a different processor unit for further processing, and clearing of the original memory can continue.

A variation of the above load sharing process can be referred to as a zero copy buffer transfer. In a zero copy system, a common shared memory pool is used by multiple processing units which do not require each processing unit to copy information between local memories. When processing control of linked processes is passed from one processing unit to another, a pointer to a memory region of the shared memory pool that is used for the linked processes is conveyed from one processing unit to the next.

Memory management of the shared memory pool can be challenging for a zero copy system. Tradition systems have a relatively easy time recovering “lost memory” resulting from internal processing errors because used memory areas are closely related to the processed that they support. Memory associated with a process can be cleared when a process fails without affecting other executing processes, since each process has its own associated memory regions. In a zero copy system, possession/ownership of a specific portion of shared memory is not obvious and returning memory when processes fail is a non-trivial procedure.

Normally, conventionally implemented zero copy messaging systems do not automatically return memory used by processes that are forced to exit. The memory used by a process that exits without manually deallocating its memory is considered lost and remains unavailable until the zero copy messaging system is reset (e.g., restarted or rebooted).

### SUMMARY OF THE INVENTION

The present invention maintains details of memory ownership of portions of a shared memory pool as messages are distributed through a zero copy messaging system. More specifically, as a memory pointer is conveyed from one processor unit to another, control of the memory region associated with the pointer is transferred. When a processing problem is encountered that causes a process to fail, any portions of the shared memory pool associated with the failed process are automatically recovered. The invention can be used for one-to-one messaging instances and for one-to-many messaging instances (e.g., multicasting messaging instances).

In one embodiment, a hash table can be maintained that associated each allocated memory region of a shared memory pool with a controlling process. If at any time a process of the system needs to exit due to an error, the zero copy messaging system can return all previously allocated memory regions associated with the exiting process to the shared memory pool, thereby allowing the returned memory to be “deallocated” or reassigned to other authorized processes.

The present invention can be implemented in accordance with numerous aspects consistent with the material presented herein. One aspect of the present invention can include a method for automatically recovering shared memory of a zero copy messaging system. The method can include a step of identifying a zero copy messaging system in which multiple processes that execute in different processing units share data contained within a shared memory pool. After one of the processes causes a portion of the shared memory pool to be allocated, the allocated portion can be identified to another process by conveying a pointer referencing the allocated portion to that process. While any of the processes are executing and while the allocated portion remains allocated, data can be maintained that indicates which of the processes are in control of the allocated portion. A failure of a controlling process can be detected, such as the processing unexpectedly exiting/aborting. When this happens, the allocated portion of memory can be automatically returned to available memory of the shared memory pool.

Another aspect of the present invention can include a method for automatically recovering memory in a zero copy messaging system. In the method, ownership can be established between processes executing in different processing units and allocated portions of a shared memory pool. The shared memory pool can be remotely located from the processing units. Ownership or control data of the allocated memory portions can be changed when control of the memory is transferred from one of the processes to another. Allocated portions of memory can be automatically recovered when processes owning the allocated portions are unexpectedly aborted before the allocated portions are able to be explicitly deallocated.

Still another aspect of the present invention can include a zero copy messaging system that includes a shared memory pool, a first and second processing unit, and a memory recovery engine. The shared memory pool can be utilized by more than one processing unit. The first processing unit can execute a first process that places information in an allocated portion of the memory pool. A pointer to the allocated portion can be conveyed from the first process to a second process. The second processing unit can execute the second process. The memory recovery engine can automatically recover the allocated portion whenever the first process or the second process fails, assuming the failing process is in control of the allocated memory at a time of failure.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow chart of a method for automatically recovering memory in a zero copy messaging system in accordance with an embodiment of the inventive arrangements disclosed herein.

FIG. 2 is a schematic diagram of a system for automatically recovering memory in a zero copy messaging system in accordance with an embodiment of the inventive arrangements disclosed herein.

FIG. 3 is a schematic diagram of various embodiments for the zero copy messaging system.

### DETAILED DESCRIPTION OF THE INVENTION

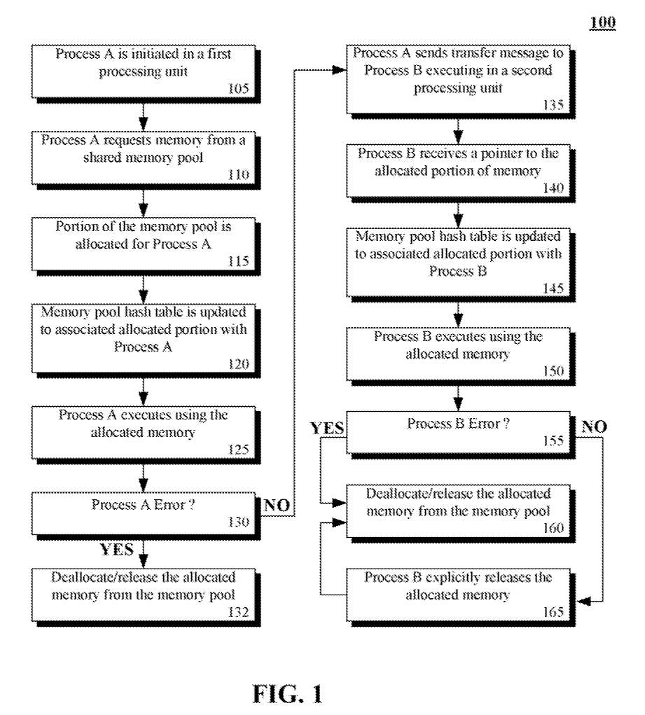

FIG. 1 is a flow chart of a method 100 for automatically recovering memory in a zero copy messaging system in accordance with an embodiment of the inventive arrangements disclosed herein. Method 100 is performed in the context of two processing units that share memory from a common pool. In various embodiments, the processors can be located in different copies of a single processor, on different processors of a single motherboard, in different components of a parallel computing array, and in different computing devices linked by a network.

Method 100 can begin in step 105, where Process A is initiated in a first processing unit. As used herein, Process A and B are used generically to represent a set of programmatic steps performed by a machine. In a multi-threaded environment, for example, each of Processes A and B can actually be threads of execution, which are subsets of a larger programmatic task. Similarly, Process A and B can each be an operation performed by a software application, where multiple lower level processes are executed in the performance of the operation.

In step 110, Process A can request memory form a shared memory pool. In step 115, a portion of memory in the pool can be allocated to Process A. Instep 120, a memory pool hash table can be updated that associates the allocated memory of the pool with Process A. In step 125, Process A can execute using the allocated memory for data storage. In step 130, the method can determine whether an error occurs involving Process A before the process finishes executing. If an error is detected, the method can proceed form step 130 to step 132, where the previously allocated memory in the memory pool that was associated with Process A can be released or deallocated.

When no error is detected and Process A executes successfully, the method can progress from step 130 to step 135, where Process A can send a transfer message to Process B, which executes in a second processing unit. In step 140, Process B can receive a pointer to the allocated portion of memory. In step 145, the memory pool hash table can be updated to associate the allocated portion of memory with Process B. In step 150, Process B can execute using the allocated memory referenced by the pointer, which Process A conveyed to Process B in step 140.

In step 150, the method can determine whether an error occurs while Process B executes. If so, the method can proceed from step 155 to step 160, where the allocated memory, which is now associated with Process B, can be released or deallocated. When no error occurs, the method can proceed from step 155 to step 165, where Process B can explicitly release the allocated memory. The method can proceed from step 165 to step 160, where the memory in the pool can be released.

The method 100 is not limited to sharing a memory space between two processes executing in different processing units. Instead, the method 100 can apply to any number of processes which share memory of the memory pool either in sequence or concurrently. When memory is shared in sequence, Process B can issue a transfer message to another process (thereby effecting looping from step 155 to step 135) instead of explicitly releasing the memory as shown in step 165.

When used concurrently (e.g. for one-to-many messaging or for multicasting), a reference count can be established for the allocated memory portion of the memory pool. Each time a new process is associated with the memory portion (i.e., is passed a pointer to the memory) the reference count can be increased. Each time a process fails and/or explicitly releases the memory, the reference count can be decreased. When the reference count reaches zero, the memory can be deallocated from the memory pool.

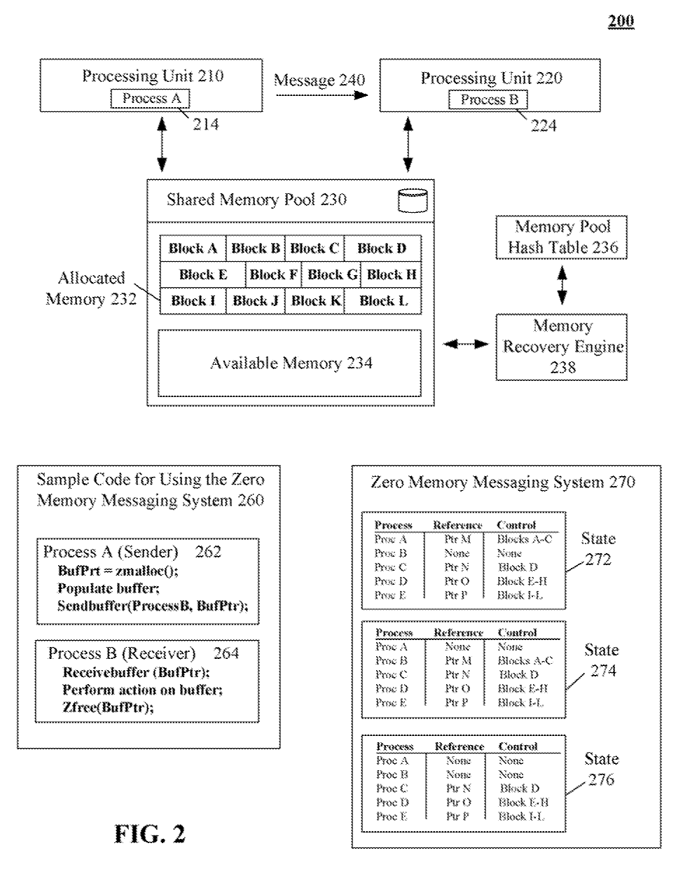

FIG. 2 is a schematic diagram of a system 200 for automatically recovering memory in a zero copy messaging system in accordance with an embodiment of the inventive arrangements disclosed herein. In one embodiment, the system 200 can be used to implement method 100.

System 200 can include two processing units 210 and 220. Processing unit 210 can execute process 214 and processing unit 220 can execute process 224. Both processes 214 and 224 can utilize a common portion of allocated memory 232 from the shared memory pool 230. An execution transfer message 240 can be conveyed from unit 210 to unit 220, which includes a pointer to a memory space used by process 214. Process 224 can utilize the memory from the pool 230, which is referenced by the pointer.

A sample use case is illustrated by the sample code 260. Code 262 shows instructions associated with process 214 and code 264 shows code associated with process 224. Code 264 can create a pointer (e.g. BufPrt) that causes a portion of previously unassigned memory 234 in the memory pool 230 to be allocated 232. For example, memory Blocks A-C can be allocated. Code 262 can then populate the buffer and send process 224 the pointer (e.g., BufPrt).

Processing unit 220 can execute code 264, which receives the memory pointer. Code 264 can then perform a programmatic action that uses the buffer. Finally, the buffer space (e.g., Blocks A-C of pool 230) can be explicitly released, which returns memory (Blocks A-C) from an allocated 232 state to an available 234 state.

If either process 214 or 224 unexpected fails due to an error, the memory recovery engine 238 can automatically release memory of the pool 230 that is assigned to the failed process. A memory pool hash table 236 can be used to track a set of processes 214-224 to which memory is allocated 232.

Chart 270 illustrates values stored in sample hash tables for different operating states 272-276. Each state 272-276 associates a set of active processes with portions of assigned memory 232 controlled by these processes.

As illustrated in chart 270, state 272 can be a state where process 214 controls the allocated memory. The table for state 272 shows that Process 214 controls memory Blocks A-C. If an error occurs for the process, the engine 238 can detect the error and cause Blocks A-C to be recovered, as shown by state 276. When message 240 is sent to transfer control of the buffer (Blocks A-C) from process 214 to process 224, the table 236 can be updated to state 274.

Memory recovery engine 238 and/or table 236 can be implemented in many different manners, each of which results in an equivalent overall effect. The hash table 236 can, for example, be stored in a reserved portion of the memory pool 230, can be stored in a memory space local to processing unit 210 and/or 220, or can be stored in a separate memory space, accessible by unit 210, unit 220, and pool 230.

The engine 238 can be implemented local to each of the processing units 210 to 220, where a controlling machine is responsible for releasing memory from the pool 230 whenever a locally executing process that is in control of the memory fails. The engine 238 can also be implemented in a machine/component distinct from either unit 210 or 220, such as a dedicated machine/component that manages memory of the pool 230.

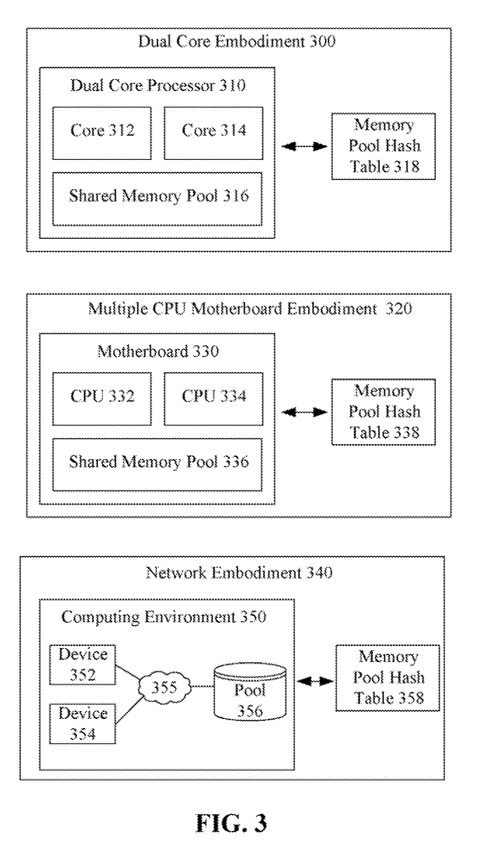

FIG. 3 is a schematic diagram of various embodiments 300, 320, and 340 for the zero copy messaging system. These embodiments 300, 320, 340 can be specific implementations for the system 200 or for any system performing the steps described in method 100. The invention is not to be limited to any of the embodiments 300-340, which are shown to illustrate a few contemplated configurations of the invention.

Embodiment 300 is a dual core embodiment for the zero copy messaging system with automatic memory recovery. The processing units of the zero copy system can be cores 312 and 314 of a dual core processor 310. The shared memory pool 316 can be an on-chip L1 and/or L2 cache memory. Memory pool hash table 318 can be a table maintained within the pool 316. Programmatic instructions executing within the processor 310 can function as the memory recovery engine.

Embodiment 320 is multiple central processing unit (CPU) embodiment for the zero copy messaging system with automatic memory recovery. The processing units of the zero copy system can be CPU 332 and CPU 334 connected to the motherboard 330. The shared memory pool 336 can be RAM memory installed within the motherboard 330. The memory pool hash table 338 can be maintained within the RAM. Programmatic instructions representing the memory recovery engine of embodiment 320 can be stored within a Complimentary Metal Oxide Semiconductor (CMOS) that is used by Basic Input Output System (BIOS), which loads at start-up.

Embodiment 340 is a network embodiment for the zero copy messaging system with automatic recovery. The processing units of the zero copy system can be computing device 352 and device 354 communicatively linked to each other via a network 355. Each computing device 352 and 354 can include a computer, a mobile telephone, a personal data assistant (PDA), a media player, an entertainment device, an embedded computing device, a wearable computer, and the like. The network 355 can include an arrangement of components for conveying digital information encoded within carrier waves between different locations. The memory pool 356 can be a network storage space communicatively linked to network 355. The memory pool hash table 358 can be stored in any network 355 accessible location. Programmatic instructions comprising the memory recovery engine can be included in device 352, 354 and/or in a different computing device linked to network 355.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carried out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for automatically recovering shared memory of a zero copy messaging system comprising:
identifying a zero copy messaging system in which a plurality of processes that each execute in different processing units share data contained within a shared memory pool, wherein after one of the processes causes a portion of the shared memory pool to be allocated, the allocated portion is identified to at least one other of the plurality of processes by conveying a pointer referencing the allocated portion to that process;
while any of the processes are executing and while the allocated portion remains allocated, maintaining data that indicates which of the processes are in control of the allocated portion;
detecting a failure of one of the processes that controls the allocated portion; and
automatically recovering the allocated portion and returning the allocated portion to available memory of the shared memory pool based upon the failure.

2. The method of claim 1, wherein one process at a time controls the allocated portion, and wherein when a controlling process fails, the automatically recovering step is performed.

3. The method of claim 1, wherein a plurality of processes at a time control the allocated portion, wherein a counter is utilized to determine a count of processes associated with the allocated portion, wherein detecting the failure results in the counter being decreased, and wherein the automatic recovering step is performed when the counter equals zero.

4. The method of claim 1, wherein the maintaining step further comprises:
utilizing a hash table to maintain the data that indicates control of the allocated portion.

5. The method of claim 1, wherein each of the plurality of processes is a thread of execution in a multi-threaded computing environment.

6. The method of claim 1, wherein each of the plurality of processes is a task in a multi-tasking computing environment.

7. The method of claim 1, wherein the detecting step and the recovering steps are performed by a machine within which the processes that fail executes, said shared memory pool being located outside the machine.

8. The method of claim 1, wherein the maintaining step is performed by at least one of a module, a library, and a driver used to implement the zero copy messaging system.

9. The method of claim 1, wherein the processing units are at least one of the following: different cores of a central processing units (CPU) having a plurality of cores, different central processing unit (CPUs) installed on a single motherboard, and different remotely located computing devices, which are communicatively linked to each other via a network.

10. The method of claim 1, wherein said steps of claim 1 are steps performed by at least one machine in accordance with at least one computer program stored within a machine readable memory, said computer program having a plurality of code sections that are executable by the at least one machine.

11. A method for automatically recovering memory in a zero copy messaging system comprising:
establishing ownership between processes executing in different processing units and allocated portions of a shared memory pool, said shared memory pool being remotely located from the processing units;
changing ownership data when control of the allocated portions is transferred from one of the processes to another; and
automatically recovering allocated portions of memory when one of the processes owning the allocated portions are unexpectedly aborted before the allocated portions are able to be explicitly deallocated by the aborted process.

12. The method of claim 11, wherein each of the plurality of processes is at least one of the following: a thread of execution in a multi-threaded computing environment, and a task in a multi-tasking computing environment.

13. The method of claim 11, wherein the processing units are at least one of the following: different cores of a central processing units (CPU) having a plurality of cores, different central processing unit (CPUs) installed on a single motherboard, and different remotely located computing devices, which are communicatively linked to each other via a network.

14. The method of claim 11, wherein said steps of claim 11 are steps performed by at least one machine in accordance with at least one computer program stored within a machine readable memory, said computer program having a plurality of code sections that are executable by the at least one machine.

15. A zero copy messaging system comprising:
a shared memory pool configured to be utilized by a plurality of processing units;
a first processing unit configured to execute a first process that places information in an allocated portion of the memory pool, wherein a pointer to the allocated portion is conveyed from the first process to a second process;
a second processing unit configured to execute the second process that accesses the allocated portion using the pointer; and
a memory recovery engine configured to automatically recover the allocated portion whenever at least one of the first process and the second process fails.

16. The system of claim 15, further comprising:
at least one memory pool hash table configured to specify which process is associated with which allocated portions of the memory pool, said memory recovery engine utilizing the memory pool hash table to perform automatic recovery actions.

17. The system of claim 15, wherein the zero copy messaging system is configured to one-to-one messaging the for one-to-many messaging.

18. The system of claim 15, wherein the first and second processing units are different cores of a central processing unit (CPU) that includes a plurality of cores.

19. The system of claim 15, wherein the first and second processing units are different central processing units (CPUs) installed on a single motherboard.

20. The system of claim 15, wherein the first and second processing units are included in different remotely located computing devices, which are communicatively linked to each other via a network.
